(19) United States
(12) Patent Application Publication
(10) Pub. No.: US 2024/0342942 A1
(43) Pub. Date: Oct. 17, 2024

(54) CUTTING DEVICE FOR SLICING FOODSTUFFS AND ASSOCIATED OPERATING METHOD

(71) Applicant: Provisur Technologies, Inc., Chicago, IL (US)

(72) Inventors: Jürgen BIALY, Oeschebüttel (DE); Aainani ABDESSAMAD, Bad Grönenbach (DE)

(73) Assignee: Provisur Technologies, Inc., Chicago, IL (US)

(21) Appl. No.: 18/413,312

(22) Filed: Jan. 16, 2024

(30) Foreign Application Priority Data
Jan. 20, 2023 (DE) 10 2023 101 402.1

(51) Int. Cl. B26D 1/157; A22C 17/00; B26D 5/02

(52) U.S. Cl. CPC B26D 1/157; A22C 17/0033; B26D 5/02; B26D 2210/02

(57) ABSTRACT

The invention relates to a cutting device (7) for cutting food products (e.g. pieces of cheese or sausage) into slices, with two parallel product feeders (8, 9) for feeding two food products into two conveyor tracks, and with two cutting blades (18, 19) for cutting the food products into slices. Furthermore, the invention comprises a corresponding operating method.

### TECHNICAL FIELD OF THE INVENTION

The invention relates to a device (“slicer”) for slicing foodstuffs (e.g. salami sticks, cheese sticks, natural ham) into slices and an associated operating method.

### BACKGROUND OF THE INVENTION

FIG. 1 shows a front view of a conventional cutting device 1 (“slicer”) for cutting food products (e.g. salami sticks, cheese sticks, etc.) into slices. The food product to be sliced is conveyed along a conveyor track by a product feed 2, which is only shown schematically here, into a cutting plane in which the food product is then cut into slices by a sickle blade 3. During operation, the sickle blade 3 rotates about a fixed axis of rotation 4, which is arranged, for example, centrally above the product feed 2 and runs parallel to the conveyor track of the product feed 2, i.e. at right angles to the cutting plane. It should also be mentioned that the sickle blade 3 sweeps over a circular cutting area 5, which covers the entire conveying track of the product feed 2, in order to cut the food products fed into the product feed 2 into slices. For technical understanding, it should also be mentioned that several balancing weights 6 are attached to the sickle blade 3 in order to balance the sickle blade 3 and enable low-vibration running of the sickle blade 3.

A disadvantage of this known cutting device 1 is the fact that only one food product can be sliced at a time, as the product feed 2 has a single track. This limits the maximum possible cutting capacity of the cutting device 1.

U.S. Pat. No. 8,616,103 B2 also discloses a multi-track cutting device that has several product feeds next to each other, so that several food products can be fed next to each other and sliced at the same time, which enables a greater slicing capacity. Here, too, only a single sickle blade is provided, which is correspondingly large and sweeps over the conveyor tracks arranged next to each other. With this multi-track cutting device, all food products are therefore sliced by the same sickle blade.

However, during operation of these multi-track slicing systems, it has been found that the shelf life of the sliced products is unsatisfactory if different food products (e.g. cheese and sausage) are sliced in the adjacent conveyor tracks and then packaged together in multi-variety package.

### DESCRIPTION OF THE INVENTION

The invention is therefore based on the task of creating an improved multi-track cutting device and a corresponding operating method.

This task is solved by a cutting device according to the invention and a corresponding operating method according to the independent claims.

The invention is based on the realization in food technology that the unsatisfactory shelf life of foodstuffs after cutting with the conventional multi-track cutting device described above is due to the fact that contamination occurs. These contaminations are caused because the cutting blade touches the different food products (e.g. cheese and sausage), so that different proteins from the different food products can come into contact with each other and react biochemically with each other, which reduces the subsequent shelf life of the packaged portions. The invention therefore comprises the general technical teaching of preventing such contaminations between different food products by means of a common cutting blade.

The cutting device according to the invention firstly has, in accordance with the known multi-track cutting device described at the beginning, at least two product feeds which are arranged next to one another and can each feed a food product along a first or second conveyor track into a first or second cutting plane.

In addition, the cutting device according to the invention, in accordance with the known multi-track cutting device described at the beginning, has a first cutting blade in order to cut the first food product fed by the first product feed along the first conveyor track into slices.

The cutting device according to the invention is now characterized in comparison with the multi-track cutting device described at the beginning in that a separate second cutting blade is provided for cutting the second food product fed in the second conveyor track from the second product feed, which cuts the second food product into slices in a second cutting plane.

In the cutting device according to the invention, a separate cutting blade is thus provided for each of the conveyor tracks, so that the individual cutting blades do not come into contact with food products that are fed in other conveyor tracks. This separate design of the cutting blades avoids the disturbing contamination described above between the neighboring conveyor tracks, which leads to a longer shelf life of the packaged portions of food.

In a preferred embodiment of the invention, the cutting blades are so-called sickle blades, each of which rotates about a stationary axis of rotation. Such sickle blades are known per se from the prior art and are also described, for example, in U.S. Pat. No. 8,616,103 B2.

However, the invention is not limited to sickle blades with regard to the type of the respective cutting blades. Rather, the cutting blades can also be so-called circular blades which rotate about a movable axis of rotation, whereby the axis of rotation in turn performs an orbital movement. Such circular blades are also well known from the prior art (see EP 0 713 753 B1, U.S. Pat. No. 4,428,263).

It should also be mentioned that the cutting planes of the two cutting blades are preferably offset plane-parallel to each other. This means that the cutting planes are aligned parallel to each other, but are arranged at a distance from each other. This makes sense in order to prevent a collision between the adjacent cutting blades. However, within the scope of the invention, it is also possible in principle for the two cutting planes to lie in a common plane. To avoid a collision between the neighboring cutting blades, they then only need to be laterally offset. It should also be mentioned that the axes of rotation of the various cutting blades are preferably offset parallel to one another.

The two cutting blades preferably each sweep over a circular cutting area, whereby the circular cutting areas of the adjacent cutting blades can overlap in an axial front view. To avoid a collision between the adjacent cutting blades, these are therefore preferably arranged in a plane-parallel offset, as already described above. In this context, it should also be mentioned that the circular cutting areas of the adjacent cutting blades can have the same diameter. However, within the scope of the invention, it is alternatively also possible for cutting blades of different sizes to be used, which then also sweep over circular cutting areas of correspondingly different sizes.

In the cutting device according to the invention, the individual cutting blades preferably have separate cutting blade drives, which serve to drive the rotation of the respective cutting blades. This makes it possible for the different cutting blades to be driven at different rotational speeds. The optimum rotational speed for slicing food products depends on the properties of the food product in question. For example, relatively soft products (e.g. yellow sausage, mortadella) should generally be sliced at low rotational speeds, while relatively hard products (e.g. smoked ham) can be sliced at relatively high rotational speeds. The rotational speed of the different cutting blade drives can therefore be set by a control unit according to the product properties (e.g. hardness) of the respective food product for each individual track. One conveyor track can therefore be cut at a low rotational speed, while another conveyor track is cut at a high rotational speed.

It should also be mentioned that in practice, the food products are cut into portions, each comprising several slices, which are then packaged together in a food package. Between slicing the individual portions, the sliced slices must first be transported away, so that the cutting process must be briefly interrupted between two successive portions. However, the rotation of the respective cutting blade cannot be interrupted during these short cutting pauses due to the mechanical inertia of the respective cutting blade. Instead, the respective cutting blade continues to rotate during the cutting pauses between the slicing of the successive portions. To avoid disruptive shredding during such idle cuts, a blade retraction mechanism is therefore preferably provided for each of the cutting blades, which moves the respective cutting blade out of the cutting plane during the idle cuts in order to then prevent contact between the cutting blade and the food product. Such blade retraction mechanisms are known per se from the prior art and are described, for example, in EP 1 046 476 A1 and U.S. Pat. No. 8,616,103 B2. A special feature according to the invention is that a separate blade retraction mechanism is provided for each of the cutting blades, so that the retraction movements of the adjacent cutting blades and the idle cuts in the adjacent conveyor tracks are possible independently of each other and individually for each track.

Thanks to the separate blade retraction mechanisms (idle cut mechanisms) and product feeds, portions with different numbers of slices can now also be cut. This means, for example, that portions with 5 slices each can be cut with the first cutting blade. The second cutting blade is used to cut portions with 6 slices each, for example. If the number of idle cuts per cutting system (i.e. per conveyor track) were the same, the portion production times would be different. In this case, an additional idle cut would be inserted in the first cutting system (i.e. in the first conveyor track). This type of production is not possible with the existing state-of-the-art cutting systems. Of course, one portion is still finished earlier, but the portion output (i.e. portions per time unit) remains constant.

In addition, it should also be mentioned that in the cutting device according to the invention, a separate feed drive is preferably provided for each of the adjacent product feeds in order to convey the respective food product in the respective conveyor track into the respective cutting plane at a track-individual feed rate. In the cutting device according to the invention, the feed rate in the adjacent conveyor tracks can therefore preferably be set individually for each track. Such feed drives are known per se from the prior art and can, for example, have grippers that grip the respective product ends and then push the food products along the respective conveyor track into the cutting plane. The movement of the grippers along the respective conveyor track can be carried out by a spindle drive, to name just one example. Alternatively or in addition to such gripper arms, conveyor belts can be used which enclose the respective food products between them and convey the food products into the respective cutting plane. Such feed drives are known, for example, from EP 0 713 753 B2 and U.S. Pat. No. 10,639,812 B2 and, in various embodiments, are also part of the general technical knowledge in the technical field of food processing machines.

It should also be mentioned that different cutting blades can also be used in the adjacent conveyor tracks, the respective design of which is adapted to the respective food product. For example, the cutting blades in the adjacent conveyor tracks can differ in at least one of the following blade properties:
Mass of the respective cutting blade,
Size of the respective cutting blade,
Blade edge angle,
Cutting edge shape of the blade edge (wavy, smooth or serrated cutting edge shape),
Blade surface (with or without non-stick coating).

The cutting blades in the adjacent conveyor tracks can therefore be adapted to the respective food products for each individual track, which enables further optimization.

In general, it should also be mentioned that the cutting blades, the cutting blade drives, the product feeds, the feed drives and/or the blade retraction mechanisms are preferably accommodated in a common housing.

It has also already been described above that the cutting blades are mounted in such a way that a collision between the adjacent cutting blades is excluded. This can be achieved by a lateral and/or an axial offset between the adjacent cutting blades.

In addition, the cutting device according to the invention preferably comprises a control unit which controls the cutting blade drives, the feed drives and/or the blade retraction mechanisms, preferably individually for each of the conveying tracks.

In general, it should also be mentioned that the invention is not limited to a cutting device with exactly two parallel conveyor tracks and correspondingly two cutting blades. Rather, it is also possible within the scope of the invention for the cutting device to have more than two (e.g. three, four, five or six) parallel conveyor tracks, each with a separate cutting blade. Even with such a larger number of parallel conveyor tracks, the control of the various components (e.g. cutting blade drives, feed drives, blade retraction mechanisms) can be carried out individually for each conveyor track.

The cutting device according to the invention was described above as a single machine. However, the invention also claims protection for a complete food processing installation which, in addition to the cutting device according to the invention described above, also comprises a packaging machine which is arranged downstream of the cutting device and packages the slices of the various food products together in a multi-variety package. Such packaging machines can, for example, be designed as thermoforming machines, as is known per se from the prior art and is part of the general technical knowledge in the technical field of food processing systems.

In this case, take-over conveyors can be arranged downstream of the cutting device in the conveying direction, which take over the cut-off slices from the cutting device, such take-over conveyors also being referred to as “jump conveyors” in accordance with the usual technical terminology. In the context of the invention, it is possible for a separate take-over conveyor to be provided for each of the adjacent conveyor tracks, whereby the individual take-over conveyors can be operated independently of one another.

In addition, a formatting conveyor can be arranged between the cutting device and the packaging machine, which formats the cut slices from the adjacent conveyor tracks into a predetermined product format for the packaging machine. For example, the cut-off slices can first be stacked in shingles, whereby the shingles are then arranged in an overlapping manner. However, the invention is not limited to a specific product format with regard to the product format produced.

Furthermore, the invention also claims protection for a corresponding operating method, whereby the individual steps of the operating method according to the invention are already apparent from the above description of the cutting device according to the invention, so that a separate description of the individual method steps can be dispensed with.

Other advantageous embodiments of the invention are characterized in the dependent claims or are explained in more detail below together with the description of the preferred embodiment of the invention with reference to the figures.

### BRIEF DESCRIPTION OF THE DRAWINGS

FIG. 1 shows an axial front view of a conventional single-track cutting device as described at the beginning of the prior art.

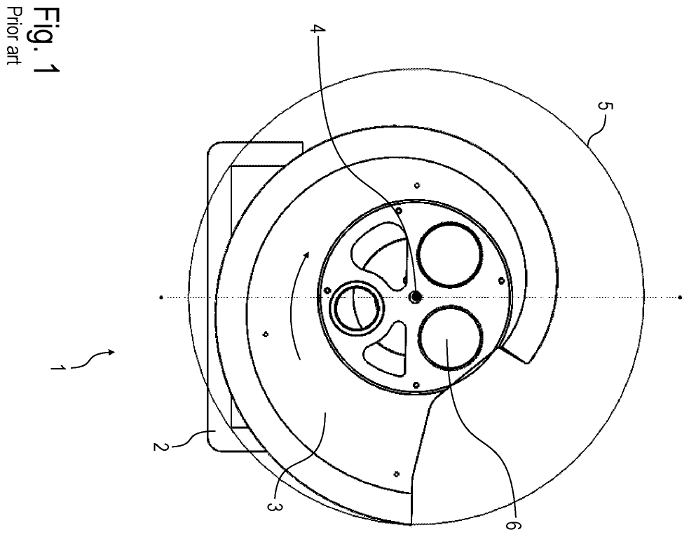

FIG. 2 shows an axial front view of a two-track cutting device according to the invention with two separate sickle blades for the two adjacent conveyor tracks.

FIG. 3 shows a top view of the cutting device as shown in FIG. 2.

FIG. 4 shows a schematic representation of the cutting device according to the invention.

FIG. 5 shows a schematic representation of a multi-variety package as produced with the cutting device according to the invention.

FIG. 6 shows a flow chart to illustrate the operating method according to the invention.

### DETAILED DESCRIPTION OF THE DRAWINGS

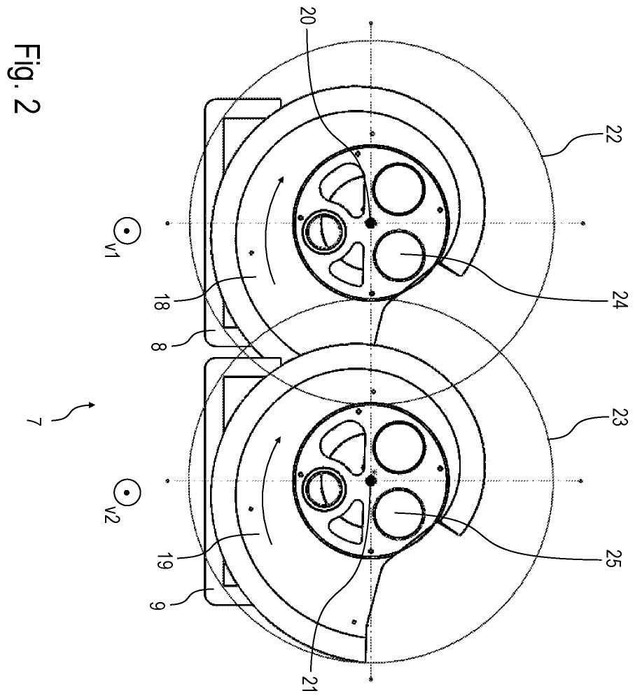

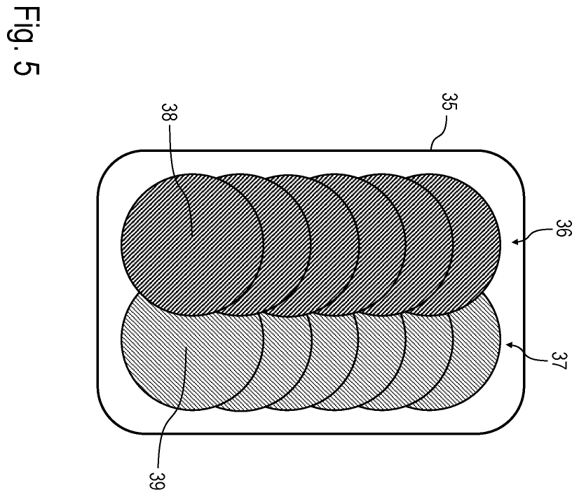

In the following, the embodiment example of a two-track cutting device 7 according to the invention is described, as shown in FIGS. 2 to 5.

The cutting device 7 according to the invention initially has two product feeds 8, 9, which are arranged next to each other and aligned parallel to each other. In each of the two product feeds 8, 9, a food product 10 or 11 can be conveyed along a conveyor track 12 or 13 into a cutting plane 14 or 15.

The food products 10, 11 are each conveyed into the respective cutting plane 14 or 15 by a separate feed drive 16, 17 with a track-specific feed rate v1, v2. The feed drives 16, 17 can be designed in a conventional manner and have, for example, grippers and/or conveyor belts to convey the food products 10, 11 into the respective cutting plane 14 or 15.

To cut the food products 10, 11 in the adjacent conveyor tracks 12, 13, two separate sickle blades 18, 19 are provided, each of which can rotate about a stationary axis of rotation 20, 21.

The two sickle blades 18, 19 each sweep over a circular cutting area 22, 23, whereby the cutting area 22 of the circular blade 18 covers the entire conveyor track 12, while the other cutting area 23 covers the other conveyor track 13.

Balancing weights 24, 25 are attached to each of the two sickle blades 18, 19 in order to balance the sickle blades 18 and 19 and to enable low-vibration running during operation.

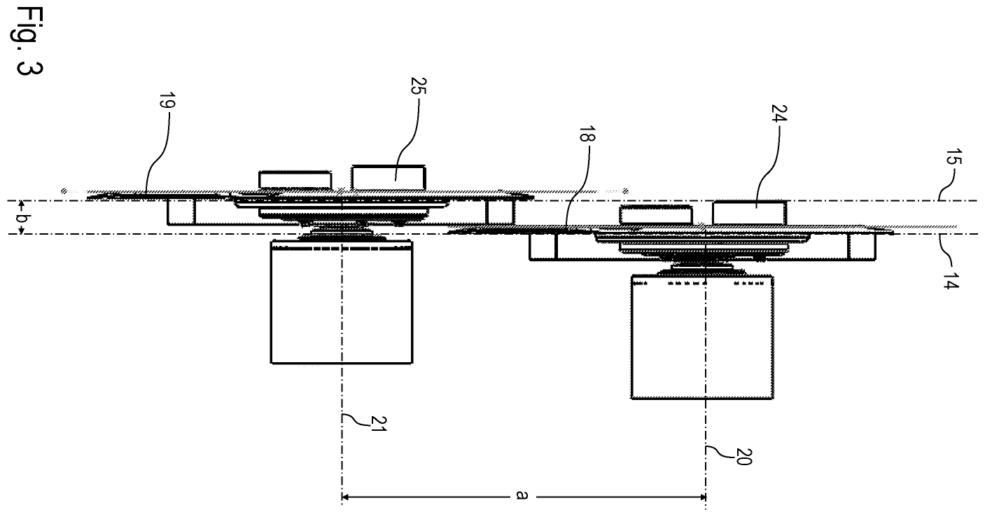

FIG. 3 shows that the two axes of rotation 20, 21 of the two sickle blades 18, 19 are offset parallel to each other at a distance a. FIG. 3 also shows that the two cutting planes 14, 15 are arranged plane-parallel and offset from each other by a distance b. This double offset in the lateral direction and in the axial direction prevents a collision between the adjacent sickle blades 18, 19.

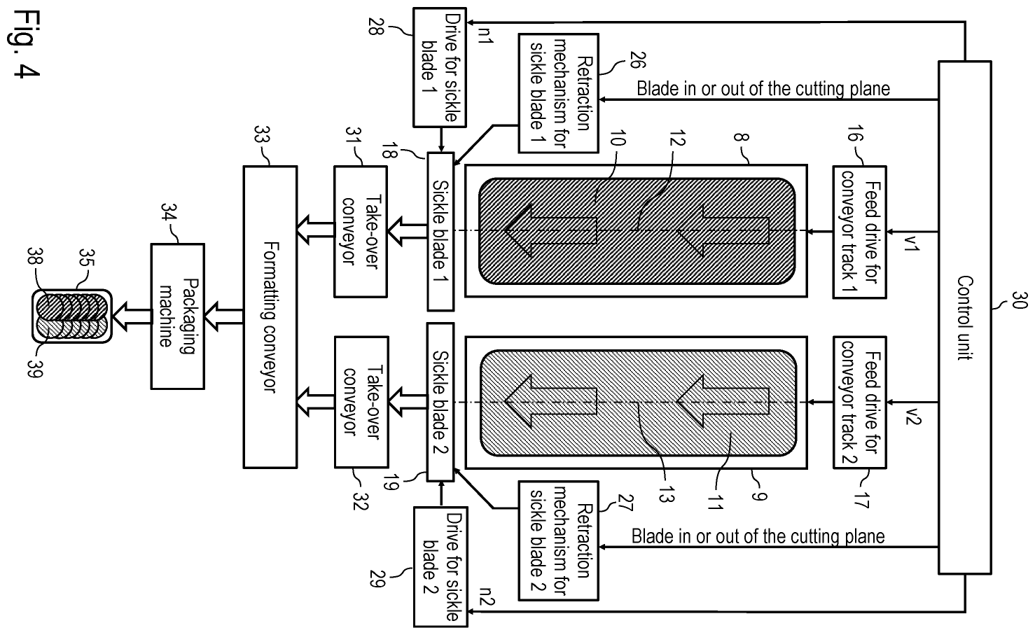

FIG. 4 also shows that the two sickle blades 18, 19 are each assigned a retraction mechanism 26 or 27. The two blade retraction mechanisms 26, 27 make it possible to move the respective sickle blade 18, 19 out of the cutting plane 14 or 15 between the cutting of successive portions during so-called idle cuts, in order to avoid disruptive shred formation during the idle cuts.

Furthermore, it can be seen from FIG. 4 that a separate cutting blade drive 28, 29 is provided for the rotational drive of each of the two sickle blades 18, 19.

The cutting device 7 is controlled by a control unit 30, which controls the two feed drives 16, 17, the two blade retraction mechanisms 26, 27 and the two cutting blade drives 28, 29 on a track-specific basis. This allows the rotational speed n1 or n2 in the two conveyor tracks 12, 13 to be adjusted individually for each track depending on the product properties of the respective food products 10, 11. For example, soft food products (e.g. yellow sausage, mortadella) are cut at a lower rotational speed than hard food products (e.g. raw ham).

The slices cut by the cutting device 7 then initially fall onto a respective take-over conveyor 31, 32, whereby the structure and mode of operation of the take-over conveyors 31, 32 are known from the prior art. Thus, the take-over conveyors 31, 32 are also referred to as “jump conveyors” in the relevant technical language.

A formatting conveyor 33 is located downstream in the conveying direction, which then formats the slices into a desired product format that is suitable for a subsequent packaging machine 34.

At the end of the process, a multi-variety package 35 is then dispensed, which contains two shingles 36, 37, wherein the shingle 36 consists of slices 38 of the food product 10, while the shingle 37 consists of slices 39 of the other food product 11. However, other product formats can also be produced and packaged within the scope of the invention.

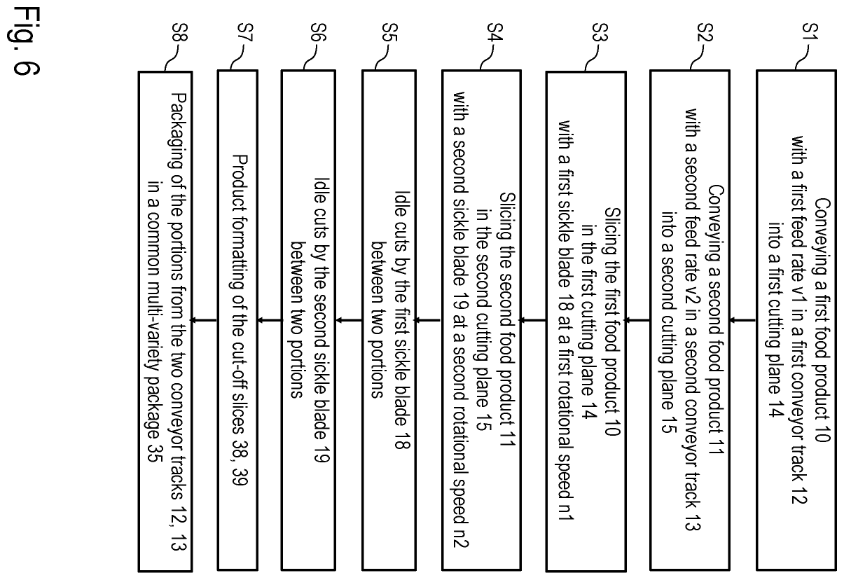

The flow chart according to FIG. 6 is now described below, which serves to illustrate the operating method according to the invention. It should be mentioned here that the steps S1-S8 described below do not take place one after the other, but partly simultaneously.

In steps S1 and S2, the two adjacent food products 10, 11 are conveyed in the adjacent conveyor tracks 12, 13 to the respective cutting planes 14, 15.

In steps S3 and S4, the food products 10, 11 are then each cut into slices 38, 39.

Between the slicing of two successive portions, idle cuts are then made in steps S5 and S6, whereby the respective sickle blades 18, 19 are each moved out of the cutting plane 14, 15 in order to avoid disruptive shredding.

The cut slices 38, 39 are then formatted in step S7.

Finally, in a step S8, the portions from the two conveyor tracks 12, 13 are packaged in a common multi-variety package 35.

The invention is not limited to the preferred embodiment example described above. Rather, the invention also claims protection for the subject matter and the features of the dependent claims independently of the claims referred to in each case and, in particular, also without the features of the main claim. The invention thus comprises different aspects of the invention which enjoy protection independently of each other.

### LIST OF REFERENCE SIGNS

1 Cutting device
2 Product feed
3 Sickle blade
4 Axis of rotation of the sickle blade
5 Cutting area of the sickle blade
6 Balancing weights on the sickle blade for balancing the sickle blade
7 Cutting device
8 First product feed
9 Second product feed
10 Food product in the first product feed
11 Food product in the second product feed
12 First conveyor track
13 Second conveyor track
14 Cutting plane of the first sickle blade
15 Cutting plane of the second sickle blade
16 Feed drive for the first conveyor track
17 Feed drive for the second conveyor track
18 First sickle blade
19 Second sickle blade
20 Axis of rotation of the first sickle blade
21 Axis of rotation of the second sickle blade
22 Cutting area of the first sickle blade
23 Cutting area of the second sickle blade
24 Balancing weights on the first sickle blade for balancing the first sickle blade
25 Balancing weights on the second sickle blade for balancing the second sickle blade
26 Blade retraction mechanism for the first sickle blade
27 Blade retraction mechanism for the second sickle blade
28 Cutting blade drive for the first sickle blade
29 Cutting blade drive for the second sickle blade
30 Control unit
31 Take-over conveyor for first conveyor track
32 Take-over conveyor for second conveyor track
33 Formatting conveyor
34 Packaging machine
35 Multi-variety package
36 Shingles of the slices of the first food product
37 Shingles the slices of the second food product
38 Slices of the first food product
39 Slices of the second food product
a Transverse offset between the axes of rotation of the two sickle blades
b Axial offset between the two cutting planes of the two sickle blades
n1 Rotational speed of the first sickle blade
n2 Rotational speed of the second sickle blade
v1 Feed rate of the food product in the first conveyor track
v2 Feed rate of the food product in the second conveyor track

1. Cutting device (7) for cutting food products into slices (38, 39), in particular for cutting pieces of cheese or sausage into slices (38, 39), with
a) a first product feed (8) for feeding a first food product (10) in a first conveyor track (12) into a first cutting plane (14),
b) a first cutting blade (18) for cutting the first food product (10) in the first cutting plane (14) into slices (38), the first cutting blade (18) being rotatable about a first axis of rotation (20) and sweeping over the first conveyor track (12) in order to slice the first food product (10) fed in the first conveyor track (12), and
c) a second product feed (9) for feeding a second food product (11) in a second conveyor track (13), wherein the second product feed (9) is arranged next to the first product feed (8),
characterized by
d) a second cutting blade (19) for cutting the second food product (11) into slices (39) in a second cutting plane (15), the second cutting blade (19) being rotatable about a second axis of rotation (21) and sweeping over the second conveyor track (13) in order to slice the second food product (11) fed in the second conveyor track (13).

2. Cutting device (7) according to claim 1, characterized in
a) that the first cutting blade (18) and/or the second cutting blade (19) is a sickle blade which rotates about a stationary axis of rotation (20, 21), or
b) that the first cutting blade and/or the second cutting blade is a circular blade which rotates about a movable axis of rotation, the axis of rotation performing an orbital movement.

3. Cutting device (7) according to one of the preceding claims, characterized in that the second cutting plane (15) of the second cutting blade (19) is arranged offset plane-parallel at a distance (b) with respect to the first cutting plane (14) of the first cutting blade (18).

4. Cutting device (7) according to one of the preceding claims, characterized in that the second axis of rotation (21) of the second cutting blade (19) is arranged offset in parallel at a distance (a) from the first axis of rotation (20) of the first cutting blade (18).

5. Cutting device (7) according to one of the preceding claims, characterized in
a) that the first cutting blade (18) sweeps over a first circular cutting area (22),
b) that the second cutting blade (19) sweeps over a second circular cutting area (23),
c) that the first circular cutting area (22) and the second circular cutting area (23) overlap in an axial front view, and
d) that the first circular cutting area (22) and the second circular cutting area (23) preferably have the same diameter.

6. Cutting device (7) according to one of the preceding claims, characterized by
a) a first cutting blade drive (28) for rotationally driving the first cutting blade (18),
b) a second cutting blade drive (29) for rotationally driving the second cutting blade (19),
c) the second cutting blade drive (29) being independent of the first cutting blade drive (28), so that the two cutting blades (18, 19) can rotate at different rotational speeds.

7. Cutting device (7) according to one of the preceding claims, characterized by
a) a first blade retraction mechanism (26) for moving the first cutting blade (18) out of the first cutting plane (14) for an idle cut,
b) a second blade retraction mechanism (27) for moving the second cutting blade (19) out of the second cutting plane (15) for an idle cut,
c) the second blade retraction mechanism (27) being independent of the first blade retraction mechanism (26), so that the idle cuts in the adjacent conveyor tracks (12, 13) are possible independently of one another.

8. Cutting device (7) according to one of the preceding claims, characterized in
a) that the first product feed (8) has a first feed drive (16) for conveying the first food product (10) in the first conveyor track (12) at a first feed rate (v1) into the first cutting plane (14),
b) that the second product feed (9) has a second feed drive (17) in order to convey the second food product (11) in the second conveyor track (13) into the second cutting plane (15) at a second feed rate (v2),
c) that the first feed drive (16) can be controlled independently of the second feed drive (17), so that the first food product (10) and the second food product (11) can be conveyed at different feed rates (v1, v2) into the first cutting plane (14) and into the second cutting plane (15), respectively.

9. Cutting device (7) according to one of the preceding claims, characterized in
a) that the first cutting blade (18) differs in its design from the second cutting blade (19) in order to enable adaptation according to the type of the first or second food product (10, 11), and/or
b) that the first cutting blade (18) differs from the second cutting blade (19) in at least one of the following blade characteristics:
b1) mass,
b2) blade cutting edge angle,
b3) cutting edge shape of the blade edge, in particular a wavy cutting edge shape or a smooth cutting edge shape or toothed cutting edge shape,
b4) blade surface, in particular with a non-stick coating or without a non-stick coating,
b5) size.

10. Cutting device (7) according to one of the preceding claims, characterized in
a) that the two cutting blades (18, 19), the two cutting blade drives (28, 29), the two product feeds (8, 9), the two feed drives (16, 17) and/or the two blade retraction mechanisms (26, 27) are accommodated in a common housing, and/or
b) that the two cutting blades (18, 19) are mounted in such a way that a collision between the two cutting blades (18, 19) is excluded, and/or
c) that a control unit (309) is provided which controls the following components independently of one another:
c1) the two cutting blade drives (28, 29), wherein the control unit (30) sets the rotational speeds (n1, n2) of the two cutting blade drives (28, 29), in particular as a function of the hardness of the respective food product (10, 11), and/or
c2) the two feed drives (16, 17), wherein the control unit (30) adjusts the feed rate (v1, v2) of the two feed drives (16, 17), and/or
c3) the two blade retraction mechanisms (26, 27), wherein the control unit (30) sets the time and the duration of the retraction movement of the two cutting blades (18, 19), and/or
d) that the two axes of rotation (20, 21) of the two cutting blades (18, 19) are arranged parallel to each other, and/or
e) that the two cutting blades (18, 19) each sweep completely over only one of the two conveyor tracks (12, 13), and/or
f) that the two cutting planes (14, 15) are each arranged at right angles to the two conveying tracks (12, 13), and/or
g) that at least one balancing weight (24, 25) is attached to each of the two cutting blades (18, 19) in order to balance the cutting blades, and/or
h) that the first feed drive (16) and/or the second feed drive (17) each has at least one of the following components:
h1) a gripper for gripping the product end of the respective food product (10, 11), wherein the gripper is displaceable along the respective conveyor track (12, 13),
h2) a gripper drive for displacing the gripper along the respective conveyor track (12, 13), in particular as a spindle drive,
h3) a conveyor belt, in particular with an upper conveyor belt and a lower conveyor belt, which enclose the respective food product (10, 11) between them.

11. Food processing installation with
a) a cutting device (7) according to one of the preceding claims, and
b) preferably a take-over conveyor (31, 32) for taking over the cut-off slices (38, 39) from the cutting device (7), in particular
b1) a first take-over conveyor (31) for taking over the slices (38) cut off by the first cutting blade (18) and
b2) a second take-over conveyor for (32) taking over the slices (39) cut off by the second cutting blade (19),
c) preferably a formatting conveyor (33) between the cutting device (7) and a packaging machine (34), the formatting conveyor (33) formatting the cut-off slices (38, 39) from the two conveyor tracks (12, 13) into a predetermined product format for the packaging machine (34), and
d) a packaging machine (34), in particular as a thermoforming machine, which is arranged downstream of the cutting device (7) and packages the slices (38, 39) of the first food product (10) together with the slices (38, 39) of the second food product (11) in a multi-variety package,

12. Operating method for a cutting device (7) for cutting food products into slices (38, 39), in particular for a cutting device (7) according to one of the preceding claims,
a) feeding a first food product (10) in a first conveyor track (12) into a first cutting plane (14),
b) cutting the first food product (10) in the first cutting plane (14) into slices (38) by means of a first cutting blade (18),
c) feeding a second food product (11) in a second conveyor track (13), wherein the second conveyor track (13) runs next to the first conveyor track (12),
characterized by the following step:
d) cutting the second food product (11) in a second cutting plane (15) into slices (39) by means of a second cutting blade.

13. Operating method according to claim 12, characterized in
a) that the first cutting blade (18) and the second cutting blade (19) are driven independently of one another, in particular at different rotational speeds (n1, n2), and/or
b) that the rotational speeds (n1, n2) are set as a function of the hardness of the respective food product (10, 11), soft food products being cut at a lower rotational speed than hard food products.

14. Operating method according to one of claims 12 to 13, characterized in
a) that the first food product (10) is cut into portions, the individual portions each containing a plurality of slices (38),
b) that between the cutting of the individual portions by the first cutting blade (18), idle cuts are made in each case,
c) that the first cutting blade (18) is moved out of the first cutting zone (14) during the idle cuts in order to avoid contact between the first cutting blade (18) and the first food product (10) during the idle cuts,
d) that the second food product (11) is cut into portions in each case, the individual portions each containing a plurality of slices (39),
e) that idle cuts are made between the cutting of the individual portions by the second cutting blade (19),
f) that the second cutting blade (19) is moved out of the second cutting plane (15) during the idle cuts in order to avoid contact between the second cutting blade (19) and the second food product (11) during the idle cuts,
g) the portions sliced in the first conveyor track (12) optionally have a different size than the portions sliced in the second conveyor track (13), in particular with regard to the number of slices contained in the respective portion.

15. Operating method according to claim 14, characterized in
a) that the first cutting blade (18) and the second cutting blade (19) are moved out of the first and second cutting planes (15) independently of one another in order to enable independent idle cuts and independent portion formation in the two conveyor tracks (12, 13), and/or
b) that the first cutting blade (18) and the second cutting blade (19) are moved out of the first or second cutting plane (15) at different times, and/or
c) that the first cutting blade (18) and the second cutting blade (19) are moved out of the first or second cutting plane (15) for different periods of time.

16. Operating method according to one of claims 12 to 15, characterized in
a) that the first food product (10) is conveyed into the first cutting plane (14) in the first conveyor track (12) at a predetermined first feed rate (v1),
b) that the second food product (11) is conveyed in the second conveying track (13) into the second cutting plane (159) at a predetermined second feed rate (v2), and
c) that the first feed rate (v1) in the first conveying track (12) is set independently of the second feed rate (v2) in the second conveying track (13).

17. Operating method according to any one of claims 12 to 16, characterized by the following step after slicing the food products (10, 11):
Packaging the slices (38) of the first food product (10) together with the slices (39) of the second food product (11) in a common multi-variety package.

18. Operating method according to one of claims 12 to 17, characterized in
a) that portions (36) of overlapping slices (39) are formed from the sliced slices (38) of the first food product (10) in each case,
b) that portions (37) of overlapping slices (39) are formed from the sliced slices (39) of the second food product (11) in each case,
c) that the portions (36) of the first food product (10) are packaged together with the portions (37) of the second food product (11) in a common multi-variety package.

19. Operating method according to one of claims 12 to 18, characterized in
a) that the first food product (10) is of a different product type than the second food product (11), and/or
b) that the first food product (10) contains other proteins than the second food product (11), and/or
c) that the first food product (10) is a cheese product, while the second food product (11) is a meat product, in particular a sausage product or a ham product.
